(19) United States
(12) Patent Application Publication
(10) Pub. No.: US 2003/0074524 A1
(43) Pub. Date: Apr. 17, 2003

(54) Mass storage caching processes for power reduction

(75) Inventor: Richard L. Coulson, Portland, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(73) Assignee: Intel Corporation, Santa Clara, CA

(21) Appl. No.: 09/981,620

(22) Filed: Oct. 16, 2001

(51) Int. Cl. G06F 12/00

(52) U.S. Cl. 711/113; 713/320; 711/137

(57) ABSTRACT

A memory system with minimal power consumption. The memory system has a disk memory, a non-volatile cache memory and a memory controller. The memory controller manages memory accesses to minimize the number of disk accesses to avoid the power consumption associated with those accesses. The controller uses the cache to satisfy requests as much as possible, avoiding disk access.

### BACKGROUND

1. Field

This disclosure relates to storage caching processes for power reduction, more particularly to caches used in mobile platforms.

2. Background

Mobile computing applications have become prevalent. Some of the tools used for these applications, such as notebook or laptop computers have a hard disk. Accessing the hard disk typically requires spinning the disk, which consumes a considerable amount of power. Operations such as reading, writing and seeking consume more power than just spinning the disk.

One possible approach is to spin down the disk aggressively, where the disk is stopped after short periods of time elapse during which no operations are performed. However, accessing the disk in this approach requires that the disk be spun back up prior to accessing it. This introduces time latency in system performance.

Conventional approaches tune the mobile systems for performance, not for power consumption. For example, most approaches write back to the hard disk, writing “through” any storage cache. Usually, this is because the cache is volatile and loses its data upon loss of power. In many mobile operations, there is a concern about loss of data.

Another performance tuning approach is to prefetch large amounts of data from the hard disk to the cache, attempting to predict what data the user wants to access most frequently. This requires the disk to spin and may actually result in storing data in the cache that may not be used. Similarly, many performance techniques avoid caching sequential streams as are common in multimedia applications. The sequential streams can pollute the cache, taking up large amounts of space but providing little performance value.

Examples of these approaches can be found in U.S. Pat. No. 4,430,712, issued Feb. 2, 1984; U.S. Pat. No. 4,468,730, issued Aug. 28, 1984; U.S. Pat. No. 4,503,501, issued Mar. 5, 1985; and U.S. Pat. No. 4,536,836, issued Aug. 20, 1985. However, none of these approaches take into account power saving issues.

### BRIEF DESCRIPTION OF THE DRAWINGS

The invention may be best understood by reading the disclosure with reference to the drawings, wherein:

FIG. 1 shows one example of a platform having a non-volatile cache memory system, in accordance with the invention.

FIG. 2 shows a flowchart of one embodiment of a process for satisfying memory operation requests, in accordance with the invention.

FIG. 3 shows a flowchart of one embodiment of a process for satisfying a read request memory operation, in accordance with the invention.

FIG. 4 shows a flowchart of one embodiment of a process for satisfying a write request memory operation, in accordance with the invention.

### DETAILED DESCRIPTION OF THE EMBODIMENTS

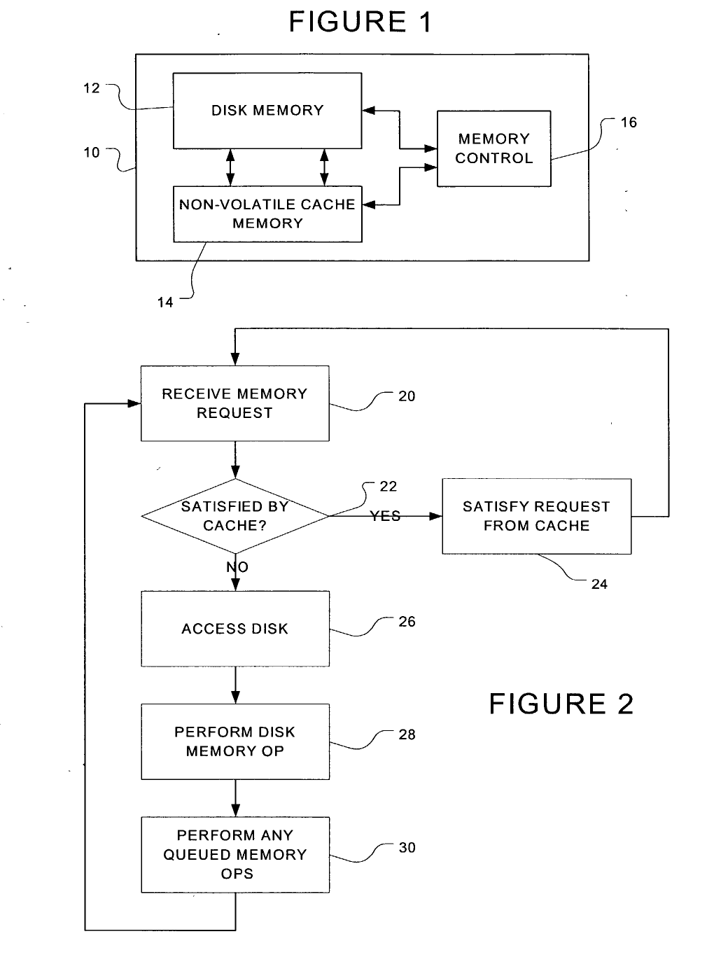

FIG. 1 shows a platform having a memory system with a non-volatile cache. The platform 10 may be any type of device that utilizes some form of permanent storage, such a hard, or fixed, disk memory. Generally, these permanent memories are slow relative to the memory technologies used for cache memories. Therefore, the cache memory is used to speed up the system and improve performance, and the slower permanent memory provides persistent storage.

The cache memory 14 may be volatile, meaning that it is erased any time power is lost, or non-volatile, which stores the data regardless of the power state. Non-volatile memory provides continuous data storage, but is generally expensive and may not be large enough to provide sufficient performance gains to justify the cost. In some applications, non-volatile memory may constitute volatile memory with a battery backup, preventing loss of data upon loss of system power.

A new type of non-volatile memory that is relatively inexpensive to manufacture is polymer ferroelectric memory. Generally, these memories comprise layers of polymer material having ferroelectric properties sandwiched between layers of electrodes. These memories can be manufactured of a sufficient size to perform as a large, mass storage cache.

Known caching approaches are tuned to provide the highest performance to the platform. However, with the use of a non-volatile cache, these approaches can be altered to provide both good performance and power management for mobile platforms. Spinning a hard disk consumes a lot of power, and accessing the disk for seek, read and write operations consumes even more. Mobile platforms typically use a battery with a finite amount of power available, so the more power consumed spinning the disk unnecessarily, the less useful time the user has with the platform before requiring a recharge. As mentioned previously, allowing the disk to spin down introduces time latencies into memory accesses, as the disk has to spin back up before it can be accessed. The non-volatile memory allows the storage controller 16 to have more options in dealing with memory requests, as well as providing significant opportunities to eliminate power consumption in the system.

Other types of systems may use other types of main memories other than hard disks. Other types of systems may include, but are not limited to, a personal computer, a server, a workstation, a router, a switch, a network appliance, a handheld computer, an instant messaging device, a pager, a mobile telephone, among many others. There may be memories that have moving parts other than hard disks. Similarly, the non-volatile memory may be of many different types. The main system memory, analogous to a hard disk, will be referred to as the storage device here, and the non-volatile cache memory will be referred to as such. However, for ease of discussion, the storage device may be referred to as a hard disk, with no intention of limiting application of the invention in any way.

The storage controller 16 may be driver code running on a central processing unit for the platform being embodied mostly in software, a dedicated hardware controller such as a digital signal processor or application specific integrated circuit, or a host processor or controller used elsewhere in the system having the capacity for controlling the memory operations. The controller will be coupled to the non-volatile cache memory to handle input-output requests for the memory system. One embodiment of method to handle memory requests is shown in FIG. 2.

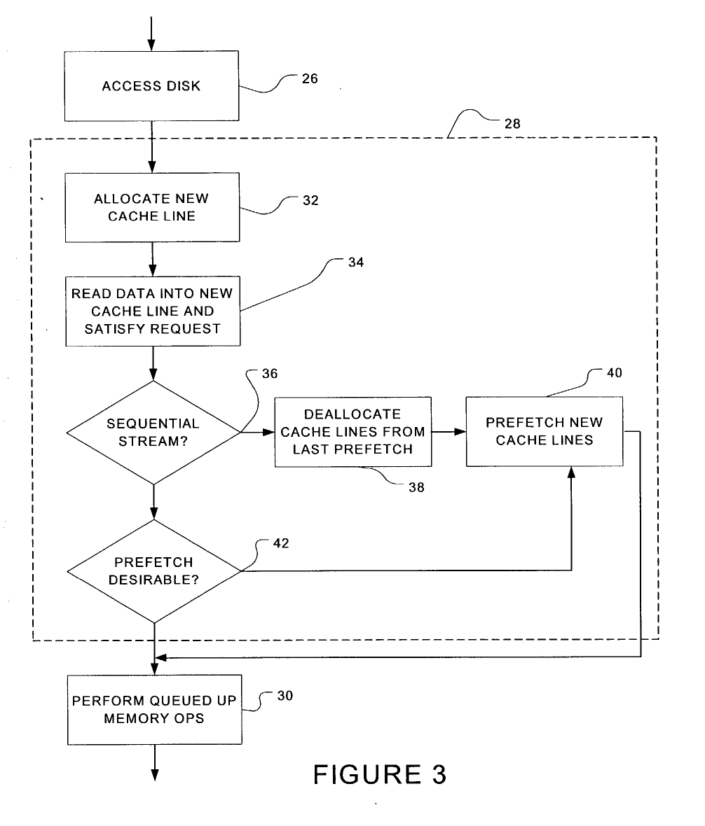

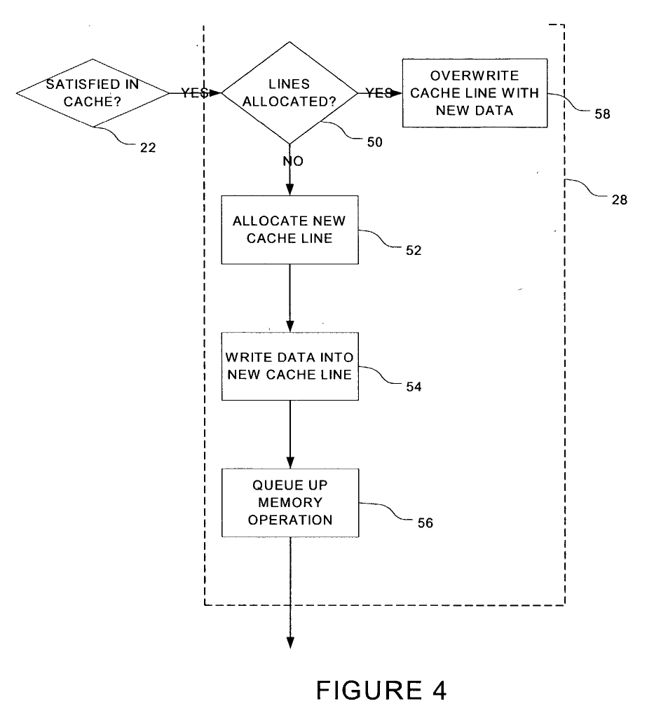

A memory request is received at 20. The memory request may be a read request or a write request, as will be discussed with regard to FIGS. 3 and 4. The memory controller will initially determine if the cache 22 can satisfy the request. Note that the term ‘satisfied’ has different connotations with regard to read requests than it does for write requests. If the cache can satisfy the request at 22, the request is satisfied at 24 and the memory controller returns to wait for another memory request at 20.

If the cache cannot satisfy the request at 22, the storage device is accessed at 26. For hard disks, this will involve spinning up the disk to make it accessible. The disk memory operation is then performed at 28. Finally, any queued memory operations will also be performed at 30. Queued memory operations may typically include writes to the disk and prefetch read operations from the disk as will be discussed in more detail later.

Having seen a general process for performing memory operations using the memory system of FIG. 1, it is now useful to turn to a more detailed description of some of the individual processes shown in FIG. 2. Typically, write requests will remain within the process of satisfying the request from cache, as the nature of satisfying the request from cache is different for write operations than it is for read operations. Write operations may also be referred to as first access requests and read operations may be referred to as second access requests.

FIG. 3 shows an example of a read operation in accordance with the invention. The process enclosed in the dotted lines corresponds to the disk memory operation 28 from FIG. 2. At this point in the process, the read request cannot be satisfied in the cache memory. Therefore, it is necessary to access the disk memory. A new cache line in the cache memory is allocated at 32 and the data is read from the disk memory to that cache line at 34. The read request is also satisfied at 34. This situation, where a read request could not be satisfied from the cache, will be referred to as a ‘read miss.’ Generally, this is the only type of request that will cause the disk to be accessed. Any other type of memory operation with either be satisfied from the cache or queued up until a read miss occurs. Since a read miss requires the hard disk to be accessed, that access cycle will also be used to coordinate transfers between the disk memory and the cache memory for the queued up memory operations.

One situation that may occur is a read request for part of a sequential stream. As mentioned previously, sequential streams are generally not prefetched by current prefetching processes. These prefetching processes attempt to proactively determine what data the user will desire to access and prefetch it, to provide better performance. However, prefetching large chunks of sequential streams does not provide a proportional performance gain, so generally current processes do not perform prefetches of sequential data streams.

Power saving techniques, however, desire to prefetch large chunks of data to avoid accessing the disk and thus consuming large amounts of power. The method of FIG. 3 checks to determine if the new data read into the cache from the disk is part of a sequential stream at 36. Generally, these sequential streams are part of a multimedia streaming application, such as music or video. If the data is part of a sequential stream, the cache lines are deallocated in the cache from the last prefetch at 38, meaning that the data in those lines is deleted, and new cache lines are prefetched at 40. The new cache lines are actually fetched, a prefetch means that the data is moved into the cache without a direct request from the memory controller.

If the data is not from a sequential stream, the controller determines whether or not a prefetch is desirable for other reasons at 42. If the prefetch is desirable, a prefetch is performed at 40. Note that prefetches of sequential streams will more than likely occur coincident with the disk memory operations. However, in some cases, including some of those prefetches performed on non-sequential streams, the prefetch may just be identified and queued up as a queued up memory operations for the next disk access, or at the end of the current queue to be performed after the other queued up memory operations occur at 30 in FIG. 2.

In summary, a read operation may be satisfied out of the cache in that the data requested may already reside in the cache. If the request cannot be satisfied out of the cache, a disk memory operation is required. In contrast, a write request will be determined to be satisfied out of the cache. Because the cache is large and nonvolatile, write requests will typically be performed local to the cache and memory operations will be queued up to synchronize data between the cache and the disk. One embodiment of a process for a write request is shown in FIG. 4.

Referring back to FIG. 2 and replicated in FIG. 4, the general process determines if the current request can be satisfied in the cache. For most write requests, the answer will be deemed to be yes. The processes contained in the dotted box of FIG. 4 correspond to the process of satisfying the request from cache at 24 in FIG. 2. At 50, the memory controller determines whether or not there are already lines allocated to the write request. This generally occurs when a write is done periodically for a particular application. For example, a write request may be generated periodically for a word processing application to update the text of a document. Usually, after the first write request for that application occurs, those lines are allocated to that particular write request. The data for the write request may change, but the same line or line set in the cache is allocated to that request.

If one or more lines are allocated to that write request at 50, the allocated ache line or lines are overwritten with the new data at 58. If the cache has no lines allocated to that request, new lines are allocated in 52 and the data is written into the allocated lines at 54. Generally, this ‘new’ memory request will not have any counterpart data in the disk memory. A disk memory operation to synchronize this newly allocated and written data is then queued up at 56 to be performed when the next disk access occurs. It might also be deferred beyond the next time the disk is spun up. Since the memory is non-volatile, the disk does not need to be updated soon.

These queued up memory operations may include the new cache writes, as just discussed, as well as prefetches of data, as discussed previously. Periodically, the memory controller may review the queue of memory operations to eliminate those that are either unnecessary or that have become unnecessary.

Several write requests may be queued up for the same write request, each with different data, for example. Using the example given above, the document may have made periodic backups in case of system failure. The memory controller does not need to perform the older ones of these requests, as it would essentially be writing the data to almost immediately write over it with new data. The redundant entries may then be removed from the queue.

A similar culling of the queue may occur with regard to read operations. A prefetch previously thought to be desirable may become unnecessary or undesirable due to a change in what the user is currently doing with the platform. For example, a prefetch of another large chunk of a sequential data stream may be in the queue based upon the user's behavior of watching a digital video file. If the user closes the application that is accessing that file, the prefetches of the sequential stream for that file become unnecessary.

In this manner, only read misses will cause the disk to be accessed. All other memory operations can be satisfied out of the cache and, if necessary, queued up to synchronize between the cache and the disk on the next disk access. This eliminates the power consumption associated with disk access, whether it be by spinning the disk, as is done currently, or both other means which may become available in the future.

Since the write operations or second memory access requests may be satisfied by writing to the cache, they may be serviced or satisfied first. Read operations may require accessing the storage device, and therefore may be serviced after the second access request.

In the case of a rotating storage device such as a hard drive, most of these operations will either begin or end with the storage device being spun down. One result of application of the invention is power saving, and spinning a rotating storage device consumes a large amount of the available power. Therefore, after a memory access request occurs that requires the hard disk to be spun up, the hard disk will more than likely be spun down in an aggressive manner to maximize power conservation.

Thus, although there has been described to this point a particular embodiment for a method and apparatus for mass storage caching with low power consumption, it is not intended that such specific references be considered as limitations upon the scope of this invention except in-so-far as set forth in the following claims.

What is claimed is:

1. A memory system, comprising:
a hard disk, wherein the hard disk must be spun to be accessed;
a cache memory, wherein the cache memory is comprised of non-volatile memory;
a memory controller, operable to:
determine if a memory request received by the memory system can be satisfied by accessing the cache memory;
queue up memory requests if the memory request cannot be satisfied by the cache memory; and
execute the memory requests queued up when the hard disk is accessed.

2. The system of claim 1, wherein the cache memory further comprises a polymer ferroelectric memory.

3. The system of claim 1, wherein the memory controller further comprises a digital signal processor.

4. The system of claim 1, wherein the memory controller further comprises an application specific integrated circuit.

5. The system of claim 1, wherein the memory controller further comprises software running on a host processor.

6. The system of claim 1, wherein the memory controller resides coincident with the cache memory.

7. The system of claim 1, wherein the memory controller resides separately from both the cache memory and the hard disk.

10. A method of processing memory requests, the method comprising:
receiving a request for a memory operation;
determining if data for the memory operation already exists in a cache memory;
performing a cache memory operation, if the data already exists in the cache;
if the data does not already exist in the cache:
accessing a hard disk that contains the data for the memory request;
performing a disk memory operation; and
performing any queued up disk memory operations.

11. The method of claim 10, wherein the memory operation is a read operation.

12. The method of claim 10, wherein accessing a hard disk further comprises spinning up the hard disk.

13. The method of claim 12, the method further comprising spinning down the hard disk after performing any queued up disk memory operations.

14. The method of claim 10, wherein if the data does not already exist in the cache, the method further comprising:
determining if the request is part of a sequential stream;
if request is part of a sequential stream, deallocating cache lines in the cache memory and prefetching new cache lines;
if request is not part of a sequential stream, determine if prefetch is desirable; and
if prefetch is desirable, prefetch data.

15. The method of claim 14, wherein the prefetch is queued up as a disk memory operation.

16. The method of claim 10, wherein performing any queued up disk memory operations further comprises determining if the queued up disk memory operations are desirable and then performing the queued up disk memory operations that are desirable.

17. The method of claim 10, wherein the memory operation is a write operation.

18. The method of claim 10, wherein the cache operation further comprises writing data into the cache.

19. The method of claim 18, wherein the cache operation further comprises queuing up a disk memory operation, wherein the disk memory operation will transfer the data to the disk.

20. The method of claim 19, wherein the queued up disk memory operations are periodically reviewed to ensure their continued desirability.

21. The method of claim 10, wherein the disk memory operation further comprises writing data to the disk.

22. The method of claim 10, wherein the queued up memory operations include writing data from the cache to the disk.

30. A method of performing a read memory operation, the method comprising:
receiving a read request;
determining if data to satisfy the read request is located in the cache;
satisfying the read request from data in the cache, if the data is located in the cache;
if the data is not located in the cache, performing a disk read operation, wherein the disk read operation comprises:
accessing the disk;
allocating a new cache line;
transferring data from the disk to the new cache line; and
satisfying the request.

31. The method of claim 30, wherein accessing the disk further comprises spinning up a hard disk.

32. The method of claim 31, wherein the method further comprises spinning down the hard disk after satisfying the request.

33. The method of claim 30, wherein the disk read operation further comprises:
determining if the data transferred from the disk to the new cache line is part of a sequential stream;
if the data is part of a sequential stream, prefetching new cache lines;
if the data is not part of a sequential stream, determining if prefetch is desirable; and
if prefetching is desirable, performing a prefetch.

34. The method of claim 30, wherein prefetching further comprises queuing up a prefetch operation to be executed during a next disk memory operation.

40. A method of performing a write memory request, the method comprising:
receiving a write request;
determining if at least one line in the cache is associated with the write request;
if at least one line in the cache is associated with the write request, performing a cache write to the line; and
if no lines in the cache are associated with the write request, performing a new write operation.

41. The method of claim 40, wherein the new write operation further comprises:
allocating a new cache line;
writing data from the write request to the line allocated; and
queuing up a disk write operation, wherein the disk write operation will transfer the new data from the cache to a disk in a later disk memory operation.

50. An apparatus comprising:
a storage device; and
a non-volatile cache memory coupled to the storage device.

51. The apparatus of claim 50 wherein the storage device includes a part capable of moving.

52. The apparatus of claim 51 further comprising:
a controller coupled to the non-volatile cache memory to queue up input-output requests while the part is not moving.

53. The apparatus of claim 51 wherein the controller is adapted to perform the queued up input-output requests while the part is not moving.

54. The apparatus of claim 51 wherein the controller comprises software.

55. The apparatus of claim 54 wherein the apparatus further comprises a general-purpose processor coupled to the non-volatile cache memory, and the software comprises a driver for execution by the general-purpose processor.

56. The apparatus of claim 50 wherein the apparatus comprises a system selected from the group comprising a personal computer, a server, a workstation, a router, a switch, and a network appliance, a handheld computer, an instant messaging device, a pager and a mobile telephone.

57. The apparatus of claim 52 wherein the controller comprises a hardware controller device.

58. The apparatus of claim 50 wherein the storage device comprises a rotating storage device.

59. The apparatus of claim 58 wherein the rotating storage device comprises a hard disk drive.

60. The apparatus of claim 59 wherein the non-volatile cache memory comprises a polymer ferroelectric memory device.

61. The apparatus of claim 59 wherein the non-volatile cache memory comprises a volatile memory and a battery backup.

70. An apparatus comprising:
a rotating storage device;
a non-volatile cache memory coupled to the rotating storage device; and
a controller coupled to the cache memory and including:
means for queue first access requests directed to the rotating storage device;
means for spinning up the rotating storage device in response to second access requests; and
means for completing the queued first access requests after the rotating storage device is spun up.

71. The apparatus of claim 70 wherein the first access requests comprise write requests.

72. The apparatus of claim 71 wherein the second access requests comprise read requests.

73. The apparatus of claim 72 wherein the read requests comprise read requests for which there is a miss by the non-volatile cache memory.

74. The apparatus of claim 71 wherein the first access requests further comprise prefetches.

75. The apparatus of claim 74 wherein the read requests comprise read requests for which there is a miss by the non-volatile cache memory.

80. A method of operating a system which includes a rotating storage device, the method comprising:
spinning down the rotating storage device;
receiving a first access request directed to the storage device;
queuing up the first access request;
receiving a second access request directed to the storage device;
in response to receiving the second access request, spinning up the rotating storage device; and
servicing the second access request.

81. The method of claim 80 further comprising:
servicing the first access request.

82. The method of claim 81 wherein the system further includes a cache coupled to the rotating storage device, and the second access request comprises a read request that misses the cache.

83. The method of claim 81 wherein the servicing of the first access request is performed after the servicing of the second access request.

84. The method of claim 83 wherein the second access request comprises a read request.

85. The method of claim 84 wherein the system further includes a cache, and the queuing up the first access request comprises recording the first access request in the cache.
